(19) United States
(12) Patent Application Publication
(10) Pub. No.: US 2014/0358918 A1
(43) Pub. Date: Dec. 4, 2014

(54) Method and Apparatus for Handling Data-Related Requests

(71) Applicant: David Castellanos Zamora, Madrid (ES)

(72) Inventor: David Castellanos Zamora, Madrid (ES)

(73) Assignee: TELEFONAKTIEBOLAGET L M ERICSSON (PUBL), Stockholm (SE)

(21) Appl. No.: 14/374,285

(22) PCT Filed: Jan. 27, 2012
(86) PCT No.: PCT/SE2012/050084

§ 371 Date: Jul. 28, 2014

(51) Int. Cl. G06F 17/30; H04W 48/18

(52) U.S. Cl. CPC G06F 17/30943; H04W 48/18
USPC 707/736

(57) ABSTRACT

A method and a request distributor (302) for dispatching data-related requests to application functions (304) connected to a data storage (306). When a first data-related request is received (3:1), a characteristic of the re-request quest is determined and a specialized application function (C) is selected (3:2) out of a set of different specialized application functions (304), based on the characteristic of the request. The first data-related request is then dispatched (3:3) to the selected specialized application function for handling of data in the data storage accordingly.

### TECHNICAL FIELD

The present disclosure relates generally to a method and a request distributor for handling data-related requests requiring retrieval of data from a data storage of a telecommunication network.

### BACKGROUND

Recently, an architecture has been developed for storing and accessing large amounts of data pertaining to subscribers in telecommunication networks, including both mobile and fixed networks, where a business logic and the actual data storage are implemented in separate layers. An example of such a type of architecture is applied to the 3GPP defined Home Subscriber Server, HSS, used to support the IP Multimedia Subsystem, IMS, and access in 4G mobile networks. The HSS also includes functionality of a Home Location Register, HLR, commonly used to support access in 2G and 3G mobile networks.

For example, the HSS/HLR is accessed by various nodes in the circuit-switched and packet-switched Evolved Packet Core, EPC and IMS network domains such as the Mobile Switching Centre, MSC, the Serving GPRS Support Node, SGSN, the Mobility Management Entity, MME, and the different nodes for Call Session Control Function, CSCF, respectively. All these nodes need to retrieve various information on their subscribers from the HSS/HLR in order to provide services to them. The following disclosure is however not limited to the examples of HSS/HLR.

The layered database architecture referred to above can be schematically illustrated as shown in FIG. 1 and can be considered to comprise a load distribution layer 100, an application layer 102 and a data layer 104. The data layer 104 is basically a data storage 104a which may be configured or implemented in different ways, e.g. with a single general database or with multiple individual databases at different locations which may store different types of data or data of different groups of subscribers, and so forth. The examples discussed in this description are basically independent of how the data layer 104 is configured or implemented, and a single data storage is generally shown to represent the data layer 104 for simplicity.

The load distribution layer 100 includes a number of load balancing nodes 100a which are configured to receive requests for data, also known as “database queries”, illustrated by an action 1:1, e.g. coming from any of the network nodes exemplified above which could also be referred to as “clients” or “requesting parties”. Such requests will be referred to as “data-related requests” in the following description, implying that retrieval of data from the database is required for processing the requests. Typically, a data-related request is, without limitation, a request for some data maintained in the data layer 104 for a subscriber, e.g. subscription settings, current location, current status, and so forth.

The load balancing nodes 100a are also configured to distribute the queries to a plurality of application functions 102a in the application layer 102, illustrated by another action 1:2, such that the load on those application functions is distributed in a suitable manner so as to not overload any particular application function, i.e. preferably more or less evenly. The application functions 102a are configured to analyze and process the incoming data-related requests, including fetching needed data from the data storage 104a, illustrated by action 1:3, and to deliver responses to the requests in a suitable manner, illustrated by action 1:4. Sometimes, conversion, translation or other processing of the retrieved data is needed before a response is delivered.

The database architecture of FIG. 1 is also referred to as a “Data Layered Architecture”, DLA. The application functions 102a in the application layer 102 are sometimes also referred to as “application front-ends”, although the term “application function” will be used throughout this description. Typically, the application functions 102a are uniformly configured and equipped to be capable of processing any type of queries when distributed from the load balancing nodes 100a. In other words, the load balancing nodes 100a can distribute any data-related request to any one of the uniform application functions 102a which generally do not maintain any subscriber data or “states”, hence being stateless such that a subsequent request for a specific subscriber, following a foregoing request for the same subscriber, does not have to be routed to the same application function having processed the foregoing request.

One problem associated with the above-described database architecture of FIG. 1 is that all application functions 102a must be capable of processing all possible types of data-related requests, which means that the application functions 102a are necessarily quite complex and extensive with great processing capacity and logic to fulfill this requirement. This requirement of deploying the same broad and thus costly functionality in all application functions is therefore naturally problematical.

Another problem is that when queries of a particular type are suddenly received in great quantities, e.g. location queries to provide some new specific location-dependent services to subscribers, the load balancing functionality will distribute the queries evenly to the application functions 102a such that virtually all of them will be impacted and potentially overloaded by this rapid rise of incoming queries. This problem may also arise at any significant increase of data-related requests which will burden virtually all application functions 102a.

Further potential problems with the above database architecture include that some types of requests, but far from all, may require execution of a specific business logic or other logic, which therefore must be supported, and possibly also executed for all other types of queries, in each and every application function. Some examples are illustrated by FIGS. 2a and 2b, showing solutions where some incoming data-related requests may require a translation or conversion of data from one form to another, e.g. between different data formats or standards, generally referred to as “data mapping”, which is done in a so-called Data Mapping Function, DMF.

In the alternative shown in FIG. 2a, queries are received by an example load balancer 200a which distributes some of them to an example application function 202a. In order to execute the data mapping for queries requiring such an operation, all queries received by this application function 202a are routed through a DMF unit 203a which execute the data mapping for those queries that need such data mapping. All other queries not needing data mapping will also be passed through the DMF unit 203a but unaffected. As a result, this solution will cause considerable delay to the query processing by running all queries to application function 202a through the DMF unit 203a, thus producing a “bottleneck” effect, while most of the queries may typically not need such a data mapping operation. There is also a need for certain logic in the DMF unit 203a for deciding which queries need the data mapping and which to pass through unaffected.

In the alternative shown in FIG. 2b, queries are likewise distributed by an example load balancer 200b to an example application function 202b. In order to execute data mapping for queries requiring such an operation, the application function 202b is equipped with a specific logic function, shown as an inserted “box”, that can detect which of the received queries require data mapping and which of them do not. The application function 202a will thus route the former queries through a DMF unit 203b and process the latter ones without running them through the DMF unit 203b. An obvious drawback with this solution is thus that the specific logic function for routing the queries is required in each and every application function, resulting in further complexity and costs. It should be noted that DMF is just an example of a specific logic that may be required for some queries and the above problem generally arises when all requests are needed to be routed through any type of additional processing circuit or logic.

### SUMMARY

It is an object of the invention to address at least some of the problems and issues outlined above. It is possible to achieve these objects and others by using a method and a request distributor as defined in the attached independent claims.

According to one aspect, a method is provided in a request distributor, for dispatching data-related requests to application functions connected to a data storage. In this method, the request distributor determines a characteristic of a first received data-related request and selects a specialized application function, out of a set of different specialized application functions, based on the determined characteristic of the first data-related request. The request distributor then dispatches the first data-related request to the selected specialized application function for handling of data in the data storage by the selected specialized application function according to the first data-related request.

According to another aspect, a request distributor is configured to dispatch data-related requests to application functions connected to a data storage. The request distributor comprises a receiving unit adapted to receive a first data-related request, and a logic unit adapted to determine a characteristic of the first data-related request. The logic unit is also adapted to select a specialized application function, out of a set of different specialized application functions, based on the determined characteristic of the first data-related request. The request distributor further comprises a dispatching unit adapted to dispatch the first data-related request to the selected specialized application function for handling of data in the data storage by the selected specialized application function according to the first data-related request.

When using the above method and request distributor, it is an advantage that the specialized application functions do not have to be capable of processing all possible types of requests but only requests with a particular characteristic, thus allowing for less complexity in the specialized application functions. Another potential advantage is that when a sudden increase in the amount of requests with a particular characteristic occurs, only the application functions being specialized therefor will be affected while other application functions in the application layer can be unaffected. Further advantages will be understood from the following detailed description.

The above method and request distributor may be configured and implemented according to different optional embodiments. In some possible embodiments, the characteristic of a data-related request may pertain to any of: a type of request, a type of requested data, and a category of subscriber. In further possible embodiments, the set of different specialized application functions may comprise any of: an HSS application function specific to support access to an IMS domain, an HSS application function specific to support access to an EPC domain, an HSS application function specific to support Multimedia Telephony, MMTEL service requests, and an HSS application function specific to support user location queries.

In another possible embodiment, the selected specialized application function may comprise multiple instances of that application function, and in that case the request distributor can apply load balancing across the instances of that application function for dispatching the first data-related request to one of the instances.

In yet another possible embodiment, when receiving a second data-related request that does not require handling by any of the specialized application functions, the request distributor may dispatch the second data-related request to a general purpose application function configured to handle any data-related requests or to one of the specialized application functions. Further, the request distributor may be implemented in a load distribution layer of a Data Layered Architecture, DLA.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a block diagram schematically illustrating a common architecture and procedure for handling data-related requests, according to the prior art.

FIGS. 2a and 2b are block diagrams schematically illustrating how data mapping of data-related requests needs to be handled, according to some examples of the prior art.

FIG. 3 is a block diagram illustrating a solution for handling data-related requests by using a request distributor, according to some possible embodiments.

FIG. 4 is a flow chart illustrating a procedure in a request distributor, according to further possible embodiments.

FIG. 5 is a flow chart illustrating a more detailed example of a procedure in a request distributor, according to further possible embodiments.

FIG. 6 is a block diagram illustrating a request distributor in more detail, according to further possible embodiments.

### DETAILED DESCRIPTION

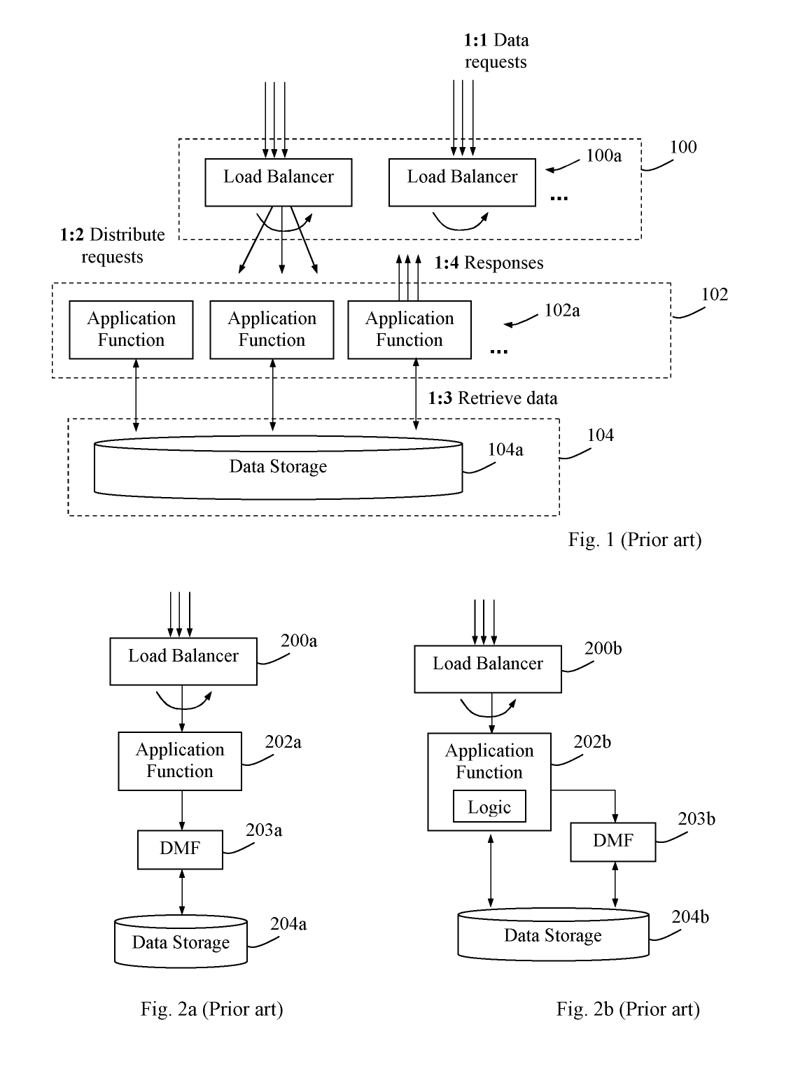

Briefly described, a solution is provided to enable less complexity in the application functions, when employing a database architecture such as the one shown in FIG. 1, also allowing for flexibility in terms of load distribution of data-related requests and limited impact on the application functions in case of a significant increase of data-related requests of a specific type. In this solution, specialized application functions are employed in the application layer which are capable of handling certain types of data-related requests with specific characteristics, which thus allows for less complexity in the specialized application functions not having to be capable of processing all possible types of requests but only the particular type of requests, hence the term “specialized”. In this solution, a specialized application function may still be actually capable of processing any type of requests but is specialized by being assigned to process certain requests with specific characteristics. The novel database architecture may contain only such specialized application functions or a mix of specialized application functions and one or more “general purpose” application functions such as the application functions used in the prior art, which will be described in more detail below.

A new functional entity is also introduced, called “request distributor”, configured to select specialized application functions to which incoming data-related requests should be dispatched for processing. In short, the request distributor selects the specialized application functions based on “characteristics” of the incoming data-related requests. The above characteristics may pertain to a type of request, a type of requested data such as e.g. location data or subscriber settings, or a category of the subscriber. For example, when several countries are involved, requests may have to be managed by a particular set of specialized application functions physically located in the country where the identity of the user, included in the request, is defined. If no specialized application function is required or suitable for a particular request, that request may be dispatched to a general purpose application function, if used, which may be configured to handle any data-related requests, thus not being specialized for any specific requests.

Further, if the database architecture comprises multiple uniform instances of a specialized application function, the request distributor may apply load balancing across the instances of that application function whenever a request shall be dispatched to that application function. The request distributor can thus be seen as an “intelligent” load balancer by distributing data-related requests to different application functions depending on characteristics of the requests. For example, if a significant increase of a particular type of data-related requests should suddenly occur, that rapid increase will only impact a specialized application function that is configured to handle that type of data-related requests, thereby “absorbing” the assailing of such data-related requests. It is thus an advantage that the other specialized application functions, and general purpose application functions, if used, will be unaffected, i.e. not overloaded and thus available to handle other types of data-related requests in a “non-congested” manner.

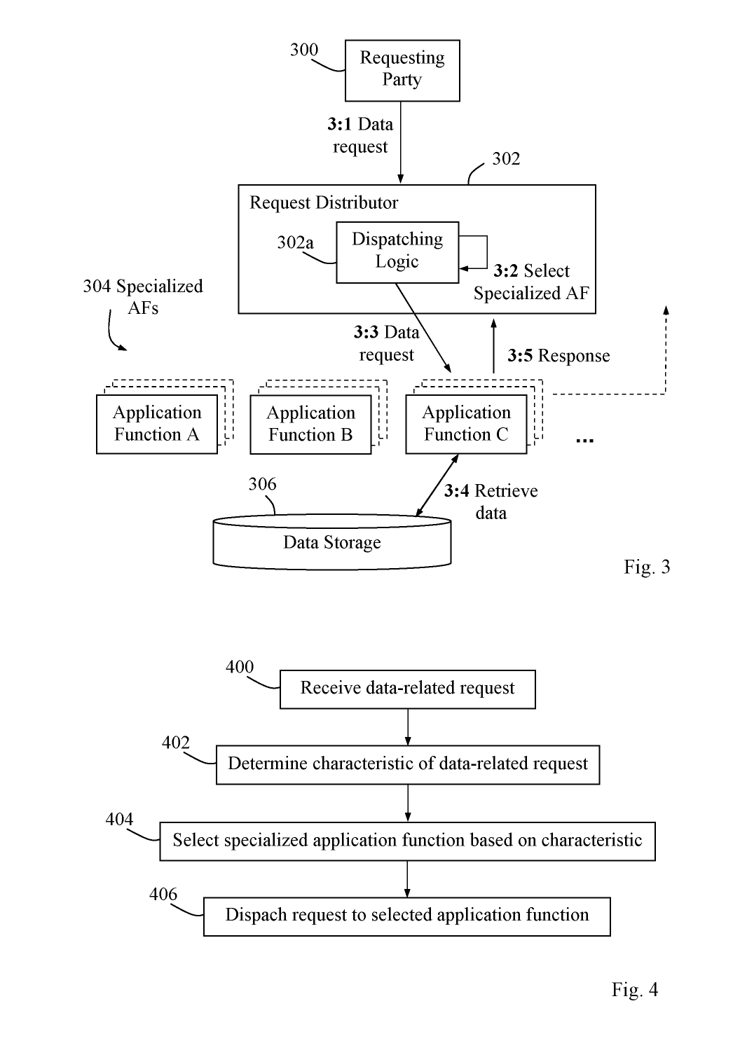

An example will now be described, with reference to FIG. 3, of how data-related requests can be handled by using a request distributor in a database architecture, e.g. a Data Layered Architecture, DLA comprising a load distribution layer, an application layer and a data layer, as similar to the architecture in FIG. 1. However, in contrast to the conventional architecture of FIG. 1, the load distribution layer comprises the newly introduced request distributor 302 and the application layer comprises a set of different specialized application functions 304, denoted A, B, C . . . in this example, each of which may comprise multiple instances as indicated by the dashed boxes. The term “specialized application function” has been explained above. The application layer may further comprise one or more general purpose application functions, not shown here, in addition to the specialized application functions 304. The data layer is represented by a data storage 306 in this figure.

In the shown procedure, a requesting party 300 issues a data-related request to the database in a first action 3:1, which is received by the request distributor 302. The data-related request may be any type of request for any type of data and for any type of subscriber or user. Further, the requesting party 300 may, without limitation to these examples, be a node in a circuit-switched or packet-switched network domain such as an MSC or an SGSN, or a node in an IMS network domain such as a Proxy P-CSCF, a Serving S-CSCF or an Interrogating I-CSCF, which are common nodes in IMS networks. The solution is thus not limited to any particular requesting parties.

In a next shown action 3:2, a schematically illustrated dispatching logic 302a in the request distributor 302 analyzes the received request in order to determine a characteristic of the request and select an appropriate specialized application function accordingly. As mentioned above, the characteristic of a received data-related request may, without limitation, pertain to any of: a type of request, a type of requested data, and a category of subscriber, and it is assumed that the dispatching logic 302a is capable of detecting any of those characteristics and others. The dispatching logic 302a thus selects one of the specialized application functions 304 in action 3:2, in this case C, based on the determined characteristic of the data-related request which is then dispatched to the selected specialized application function C in another action 3:3.

The application function C will then handle data in the data storage 306 according to the first data-related request, schematically illustrated by action 3:4, e.g. involving a data mapping operation and/or any other processing operation depending on the requirements for this specific request. Application function C finally delivers a suitable response in a last shown action 3:5, which may be issued to the requesting party 300 via the request distributor 302 or directly from the application function C as shown by a dashed arrow. The performance of actions 3:4 and 3:5 lies somewhat outside the scope of this solution and may basically be performed in a conventional manner not necessary to describe here in any detail to understand the solution.

A procedure in a request distributor for dispatching data-related requests to application functions connected to a data storage, will now be described with reference to the flow chart in FIG. 4, illustrating actions executed in the request distributor. The request distributor 302 described for FIG. 3 may be used also in the procedure of FIG. 4.

In the following example, the request distributor basically operates to distribute different data-related requests to a set of different specialized application functions in a data layered architecture, such as the application functions 304 shown in FIG. 3, as follows. In this example, the specialized application functions may, without limitation, comprise any of: an HSS application function specific to support access to an IMS domain, an HSS application function specific to support access to an EPC domain, an HSS application function specific to support MMTEL service requests, and an HSS application function specific to support user location queries, to mention a few possible examples. Further, the request distributor may be implemented in a load distribution layer of a Data Layered Architecture, i.e. in the above-described DLA.

In a first action 400, the request distributor receives a first data-related request, or “data query”, which could come from any requesting party, basically corresponding to action 3:1 in FIG. 3. The request distributor then analyzes the request and determines a characteristic of the received first data-related request, in a following action 402. As mentioned above, the characteristic of a data-related request may pertain to a type of request, a type of requested data, and/or a category of subscriber, to mention a few possible examples.

In a further action 404, the request distributor selects a specialized application function, out of a set of different specialized application functions, based on the determined characteristic of the first data-related request, basically as of action 3:2 in FIG. 3. In this action, an application function is selected that is specifically adapted to handle requests with that characteristic. The request distributor finally dispatches the first data-related request to the selected specialized application function, in a last shown action 406, basically corresponding to action 3:3 in FIG. 3, for handling of data in the data storage by the selected specialized application function according to the first data-related request. The following process of handling the request in the selected specialized application function is not shown in this figure.

As in the previous example, one or more of the set of different specialized application functions may comprise multiple uniform instances which have basically the same ability to handle requests with a certain characteristic. Thus, if the selected specialized application function above comprises such multiple instances, load balancing may be applied across the instances of that specialized application function for dispatching the first data-related request to one of those instances. Thereby, the load of handling requests with this particular characteristic can be evenly distributed among the instances of that specialized application function although without affecting the other application functions in the architecture. For example, if some type of requests should greatly increase for some reason, the impact of this increase can be limited to only affect this specialized application function while others will remain untouched.

Further, the load distribution layer of the data layered architecture may additionally comprise one or more general purpose application functions that can handle data-related requests with any characteristic, i.e. not being specialized with respect to any particular request characteristic, as described above. Thus, when a second data-related request is received that has any characteristic, or that does not require handling by any of the specialized application functions, the second data-related request may be dispatched to one of the general purpose application functions. Alternatively, the second data-related request may be dispatched to one of the specialized application functions anyway provided that the second request does not have a characteristic outside the ability of that specialized application function.

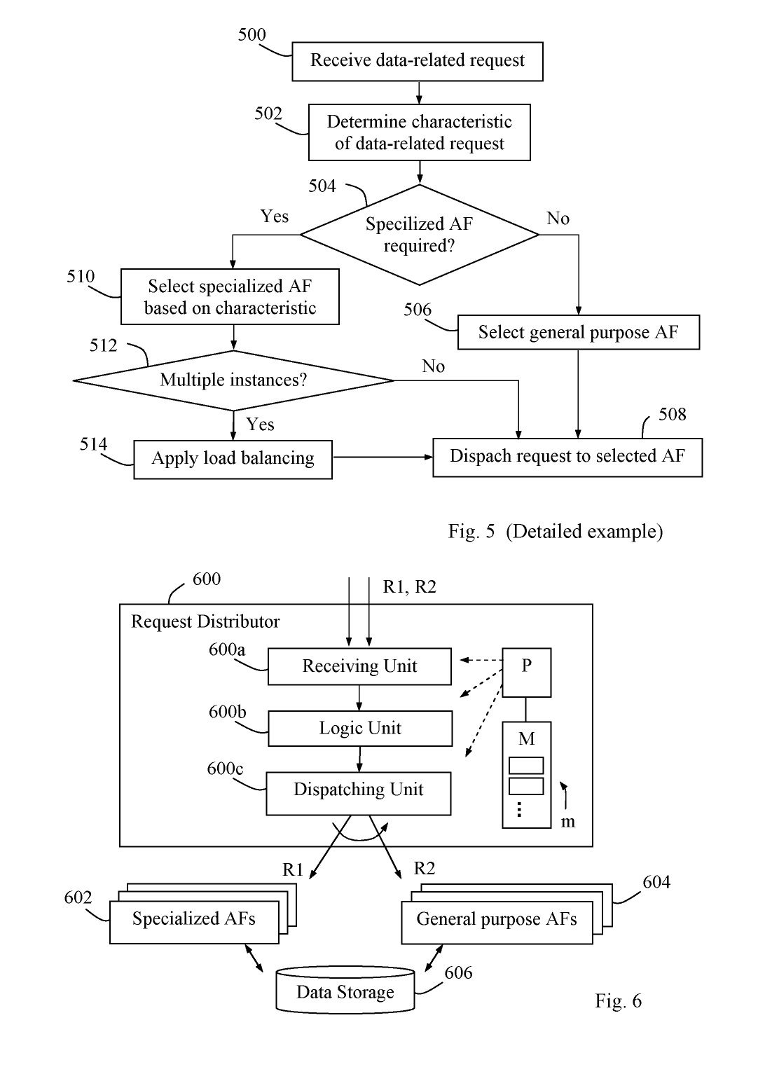

A more detailed example of dispatching data-related requests to application functions, will now be described with reference to the flow chart in FIG. 5, again in terms of actions executed in a request distributor configured according to this solution. In this example, it is assumed that the application functions comprise both specialized application functions and at least one general purpose application function, and further that some of the specialized application functions has multiple uniform instances across which load balancing can be applied, as described for the previous examples.

A first action 500 illustrates that a data-related request is received by the request distributor, just as in the previous examples. A next action 502 illustrates that the request distributor proceeds with determining a characteristic of the received data-related request. It is then determined in an action 504 whether the received request requires handling by a specialized application function or not, depending on its characteristic. If not, a general purpose application function can be selected in an action 506 and the request is accordingly dispatched to the selected application function in a next action 508. Alternatively, one of the specialized application functions may be selected here anyway, i.e. even when this is not required by the request, provided that this specialized application function is actually capable of handling the received request, which may be suitable in a situation when the general purpose application function is currently overloaded and the selected specialized application function is not.

On the other hand, if it is found in action 504 that the received request actually requires handling by a specialized application function, analogous with the procedure of FIG. 4, the request distributor proceeds with selecting one of the specialized application functions based on the determined characteristic of the request, in a further action 510, i.e. an application function that is specifically adapted or configured to handle requests with that specific characteristic.

It is then determined in an action 512 whether the selected specialized application function comprises multiple uniform instances or not. If that is the case, the request distributor applies load balancing across the instances of the selected specialized application function, in a further action 514, for selecting one of those instances in a way that distributes the load evenly over the instances. The request distributor then accordingly dispatches the received data-related request to that instance of the selected application function, by moving to action 508 in the shown procedure.

The above procedure in FIG. 5 may be modified in different ways within the scope of this solution. For example, the characteristic of the received data-related request may be further analyzed after determining that the request requires handling by a specialized application function such that the action 502 of determining the “characteristic” is made in two steps, first after action 500 as shown and then after “yes” of action 504, not shown. In another example, in the case when the general purpose application function selected in action 504 has multiple instances as well, load balancing may be applied across the instances of that application function, i.e. analogous with performing actions 512 and 414 after action 506.

A detailed but non-limiting example of how a request distributor can be configured to accomplish the above-described solution, is illustrated by the block diagram in FIG. 6. The request distributor 600 is configured to dispatch data-related requests to application functions 602, 604 connected to a data storage 606, e.g. according to the procedures described above for any of FIGS. 3-5, respectively. The request distributor 600 will now be described in terms of a possible example of employing the solution. In this example, a Data Layered Architecture, DLA may be assumed comprising a load distribution layer where the request distributor 600 is implemented, an application layer with the application functions 602, 604 and a data layer with the data storage 606.

The request distributor 600 comprises a receiving unit 600a adapted to receive a first data-related request “R1”. The request distributor 600 also comprises a logic unit 600b adapted to determine a characteristic of the received first data-related request R1, e.g. as described in actions 402 and 508 above, and to select a specialized application function 602 for the first request R1 based on the determined characteristic of the first data-related request R1, e.g. as described in actions 404 and 510 above. As in the above examples, the determined characteristic may pertain to any of: a type of request, a type of requested data, and a category of subscriber. Further, the set of different specialized application functions may comprise any of: an HSS application function specific to support access to an IMS domain, an HSS application function specific to support access to an EPC domain, an HSS application function specific to support MMTEL service requests, and an HSS application function specific to support user location queries.

The request distributor 600 further comprises a dispatching unit 600c adapted to dispatch the first data-related request R1 to the selected specialized application function 602 for handling of data in the data storage 606 by the selected specialized application function according to the first data-related request, i.e. to serve the first request R1 in an appropriate manner.

The above request distributor 600 and its functional units 600a-c may be configured or adapted to operate according to various optional embodiments. In one possible embodiment, if the selected specialized application function comprises multiple instances of that application function, the dispatching unit 600c may be further adapted to apply load balancing across the instances of that application function for dispatching the first data-related request to one of those instances.

In another possible embodiment, the receiving unit 600a is further adapted to receive a second data-related request “R2” that does not require handling by any of the specialized application functions. The logic unit 600b may in that case be further adapted to select a general purpose application function 604 configured to handle any data-related requests, for the second request R2. Alternatively, the logic unit 600b may be adapted to select one of the specialized application functions 602 for the second request R2, e.g. if the general purpose application function 604 is highly loaded in comparison or otherwise currently unsuitable. In either case, the dispatching unit 600c is further adapted to dispatch the second data-related request R2 to the selected application function, in the figure exemplified as the general purpose application function 604.

It should be noted that FIG. 6 illustrates various functional units in the request distributor 600 and the skilled person is able to implement these functional units in practice using suitable software and hardware means. Thus, this aspect of the solution is generally not limited to the shown structures of the request distributor 600, and the functional units 600a-c may be configured to operate according to any of the features described in this disclosure, where appropriate.

The functional units 600a-c described above can be implemented in the request distributor 600 by means of program modules of a respective computer program comprising code means which, when run by processors “P” causes the request distributor 600 to perform the above-described actions. Each processor P may comprise a single Central Processing Unit (CPU), or could comprise two or more processing units. For example, each processor P may include general purpose microprocessors, instruction set processors and/or related chips sets and/or special purpose microprocessors such as Application Specific Integrated Circuits (ASICs). Each processor P may also comprise a storage for caching purposes.

Each computer program may be carried by a computer program product “M” in the request distributor 600 in the form of a memory having a computer readable medium and being connected to the processor P. Each computer program product M or memory thus comprises a computer readable medium on which the computer program is stored e.g. in the form of computer program modules “m”. For example, the memory M may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the request distributor 600.

By using the specialized application functions as described above, it is not required that all application functions in an application layer must be capable of processing all possible types of data-related requests. The specialized application functions can therefore be made less complex and with a limited processing capacity and logic needed to be able to serve data-related requests of the characteristic they are specialized for. Further, a sudden increase in the amount of requests with a particular characteristic will have only a limited impact on the application functions being specialized therefor and not on other application functions in the application layer. Further advantages have been explained in the examples above.

While the solution has been described with reference to specific exemplary embodiments, the description is generally only intended to illustrate the inventive concept and should not be taken as limiting the scope of the solution. For example, the terms “request distributor”, “data-related request”, “characteristic”, “specialized application function”, “general purpose application function” and “data storage” have been used throughout this description, although any other corresponding nodes, functions, and/or parameters could also be used having the features and characteristics described here. The solution is defined by the appended claims.

1. A method in a request distributor for dispatching data-related requests to application functions connected to a data storage, the method comprising:
determining a characteristic of a first received data-related request,
selecting a specialized application function, out of a set of different specialized application functions, based on the determined characteristic of said first data-related request, and
dispatching the first data-related request to the selected specialized application function for handling of data in the data storage by the selected specialized application function according to the first data-related request.

2. The method according to claim 1, wherein said characteristic pertains to any of: a type of request, a type of requested data, and a category of subscriber associated with requested data.

3. The method according to claim 1, wherein said set of different specialized application functions comprises any of: an HSS application function specific to support access to an IMS domain, an HSS application function specific to support access to an EPC domain, an HSS application function specific to support Multimedia Telephony MMTEL service requests, and an HSS application function specific to support user location queries.

4. The method according to claim 1, wherein the selected specialized application function comprises multiple instances of that application function, and load balancing is applied across said instances of that application function for dispatching the first data-related request to one of said instances.

5. The method according to claim 1, wherein when a second received data-related request does not require handling by any of said specialized application functions, the second data-related request is dispatched to a general purpose application function configured to handle any data-related requests or to one of said specialized application functions.

6. The method according to claim 1, wherein the request distributor is implemented in a load distribution layer of a Data Layered Architecture, DLA.

7. A request distributor configured to dispatch data-related requests to application functions connected to a data storage, the request distributor comprising one or more processing circuits configured to:
receive a first data-related request,
determine a characteristic of said first data-related request, and to select a specialized application function, out of a set of different specialized application functions, based on the determined characteristic of said first data-related request, and
dispatch the first data-related request to the selected specialized application function for handling of data in the data storage by the selected specialized application function according to the first data-related request.

8. The request distributor according to claim 7, wherein said characteristic pertains to any of: a type of request, a type of requested data, and a category of subscriber associated with the requested data.

9. The request distributor according to claim 7, wherein said set of different specialized application functions comprises any of: an HSS application function specific to support access to an IMS domain, an HSS application function specific to support access to an EPC domain, an HSS application function specific to support Multimedia Telephony MMTEL service requests, and an HSS application function specific to support user location queries.

10. The request distributor according to claim 7, wherein the selected specialized application function comprises multiple instances of that application function, and the one or more processing circuits are further adapted to apply load balancing across said instances of that application function for dispatching the first data-related request to one of said instances.

11. The request distributor according to claim 7, wherein the one or more processing circuits are further adapted to receive a second data-related request that does not require handling by any of said specialized application functions, to select a general purpose application function configured to handle any data-related requests, or to select one of said specialized application functions, and to dispatch the second data-related request to the selected application function.

12. The request distributor according to claim 7, wherein the request distributor is implemented in a load distribution layer of a Data Layered Architecture, DLA.
